(19) United States
(12) Patent Application Publication
(10) Pub. No.: US 2024/0155739 A1
(43) Pub. Date: May 9, 2024

(54) Apparatus for Heating and Maintaining Quartz Labware at Vaporization Temperatures

(71) Applicant: Old Head LLC, Orange, CA (US)

(72) Inventor: Brian Roueiheb, Anaheim, CA (US)

(21) Appl. No.: 18/449,456

(22) Filed: Aug. 14, 2023

Related U.S. Application Data
(60) Provisional application No. 63/382,202, filed on Nov. 3, 2022.

(51) Int. Cl. H05B 3/06; H05B 1/02

(52) U.S. Cl. CPC H05B 3/06; H05B 1/023

(57) ABSTRACT

A heating device designed to heat and maintain a quartz labware at a desired temperature for use in vaporizing concentrates and essential oils. The present invention includes a case, a heating element, a temperature sensor, a user interface, and a quartz labware. The heating element is shaped in the form of a receptacle, designed to receive and heat the quartz labware. After attaching the quartz labware to the heating element, the user simply turns on the device and sets the desired temperature. The device then heats up the quartz labware until reaching the desired temperature. The desired temperature is maintained until the user removes the quartz labware. In another embodiment, the present invention includes an accessory. The accessory contains a plurality of spheres that become thermally charged when heated. After heating, the user can use the accessory to extract vapors from dried herbs and flowers.

### FIELD OF THE INVENTION

The present invention relates generally to a heating apparatus. More specifically the present invention is a heating apparatus designed to heat and maintain quartz labware at a desired temperature.

### BACKGROUND OF THE INVENTION

Concentrates and essential oils are compounds that are vaporized for numerous reasons including aromatherapy. Extracting these vapors requires heating the concentrates or essential oils to a specific temperature. The preferred method of vaporization involves using quartz labware designed to thermally extract oils, but the current method of heating this labware is quite crude and involves first heating the quartz labware with an open torch flame until the temperature reaches in excess of 800° F. Using a temperature-sensing device, the user must then monitor the temperature of the quartz labware until it drops to the desired temperature. Once the desired temperature is reached, the user can then add the concentrates or essential oils into the quartz labware for proper vaporization.

It is an objective of the present invention to provide a solution to the aforementioned problems. The present invention is a heating apparatus designed to heat and maintain a quartz labware at a desired temperature for use in vaporizing concentrates and essential oils. Alternatively, the present invention can be used to heat and maintain an accessory at a desired temperature for use in extracting vapors from dried herbs or flowers. Thus, the present invention helps automate the entire vaporization process by eliminating the time-consuming steps, need for an open flame, and reliance on combustible fuels of the current method.

### SUMMARY

The present invention is an apparatus for heating and maintaining the temperature of a piece of quartz extraction labware (quartz labware). The heating element is uniquely designed in the shape of a cup for heating the quartz labware. A temperature sensor is affixed within/to or near the heating element to detect the temperature at the heating element. A heat guard surrounds the heating element to protect the user from inadvertently touching the heating element during the heating process. After inserting the quartz labware into the heating element, the user can set the desired temperature via the user interface. Optionally, the present invention can be configured to transmit the desired temperature wirelessly, via a mobile app or other wireless device. Once the desired temperature is set, the heating element is then heated to and maintained at the desired temperature. A microcontroller continually adjusts the power to the heating element in order to maintain the desired temperature. In turn, the quartz labware is also heated to the desired temperature and then held at this temperature until further use.

The heating element does not heat the stem of the quartz labware, so the user is able to easily remove and handle the quartz labware by the stem without using protective gloves. The heated quartz labware is then connected to the user's preferred glass labware. Then, concentrates or essential oils can be added to the quartz labware where vapors are extracted.

Alternatively, the present invention can be used in combination with an accessory. The accessory includes a head, a peen, and a shank. The head is a titanium container packed with ruby spheres. Each of the ruby spheres have high thermal conductivity when heated and work as an effective insulator to retain that heat. The peen fits over the head and a plurality of inlet and outlet holes enable air to pass through the head and peen. To use the accessory, the user first places the head into the heating element. After heating the head to the desired temperature, the ruby spheres become thermally charged. The user then removes the accessory from the heating element, and connects the accessory to a herb/flower extraction chamber. The extraction chamber, in turn, is connected to the user's preferred glass labware. With this configuration, ambient air is pulled through the head, where it is heated by the ruby spheres. Thereafter, the heated air travels through the peen and into the extraction chamber, where vapors from the dry herbs and flowers are thermally extracted.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a left-side elevational view of the present invention.

FIG. 4 is an enlarged, cross-sectional view taken along line 4-4 in FIG. 3.

FIG. 5 is a top-front-left perspective view of the present invention, shown without the quartz labware.

FIG. 6 is a front elevational view of the present invention, shown without the quartz labware.

FIG. 7 is a rear elevational view of the present invention.

FIG. 8 is a top plan view of the present invention, shown without the quartz labware.

FIG. 9 is a bottom plan view of the present invention.

FIG. 10 is a block diagram of the present invention, wherein thinner flowlines represent electrical connections between components and thicker flowlines represent electronic connections between components.

FIG. 11 is a block diagram of the present invention, in accordance with another embodiment, wherein thinner flowlines represent electrical connections between components, thicker flowlines represent electronic connections between components, and dashed flow lines indicate the components being communicably coupled.

FIG. 12 is a perspective view of the quartz labware of the present invention.

FIG. 13 is a top-front-left perspective view of the present invention, in accordance with another embodiment.

FIG. 14 is a top-front perspective view of the accessory of the present invention.

FIG. 15 is a top-front perspective exploded view of the accessory of the present invention.

FIG. 16 is a bottom-rear perspective view of the accessory of the present invention.

### DETAIL DESCRIPTIONS OF THE INVENTION

All illustrations of the drawings are for the purpose of describing selected versions of the present invention and are not intended to limit the scope of the present invention.

Hereinafter, the term “extraction implement” refers to any heat-resistant receptacle that is specifically designed for the purpose of extracting a compound of interest from a mixture (e.g., essential oils) or organic material (e.g., herbs) by way of vaporization.

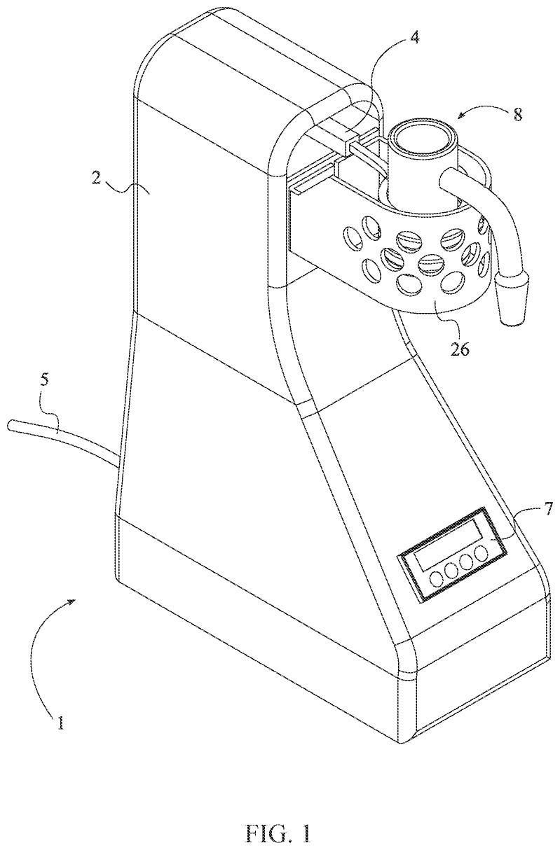

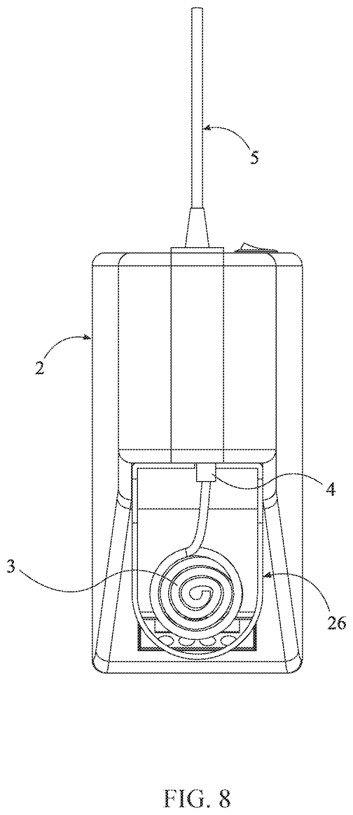

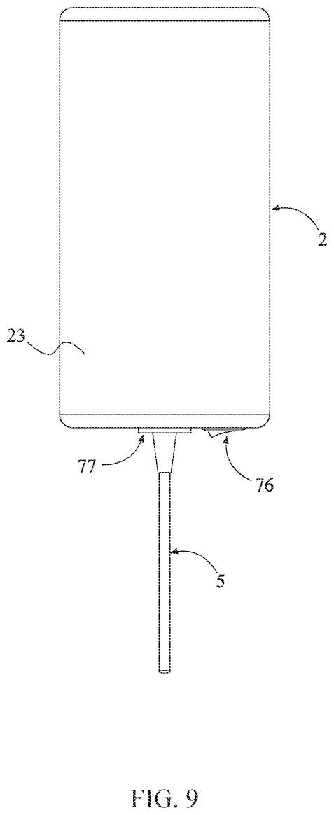

In reference to FIG. 1 through FIG. 12, the present invention is a heating apparatus 1 for heating and maintaining the temperature of a quartz labware 8. It is an aim of the present invention to provide a convenient and efficient way of heating the quartz labware 8 to a desired temperature for the purpose of vaporizing concentrates and essential oils. To use the present invention, the user begins by first connecting the power source 5 of the device to a standard wall outlet and then turning on the device. Next, the user adjusts the settings on the user interface 7 to set the desired temperature. The quartz labware 8 is then positioned within the heating element 3 of the device, which in turn, heats the quartz labware 8 to the desired temperature. A microcontroller 6 within the device continually adjusts the power supplied to the heating element 3 in order to maintain the temperature of the quartz labware 8 at the desired temperature. When ready to use, the user simply picks up the quartz extraction labware at the stem 82, and connects the stem 82 to the user's preferred glass labware. Since the stem 82 is not in contact with the heating element 3, the user is able to pick up the quartz labware 8 without using protective gloves. The user can then add the concentrates or essential oils into the bucket 81 of the quartz labware 8. Thereafter, the quartz labware 8 can be used in combination with the user's preferred glass labware to extract the vaporized concentrates or essential oils out of the quartz labware 8, via the stem 82.

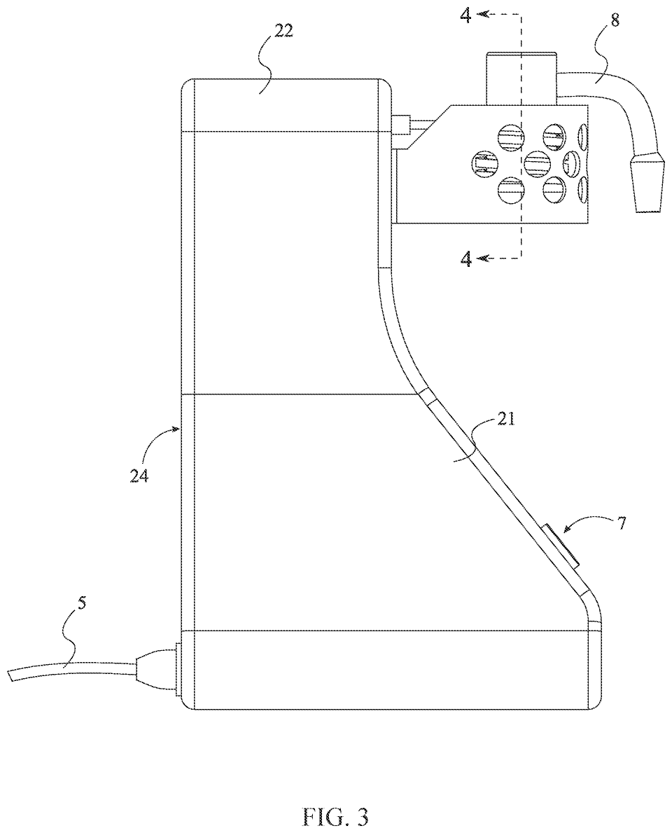

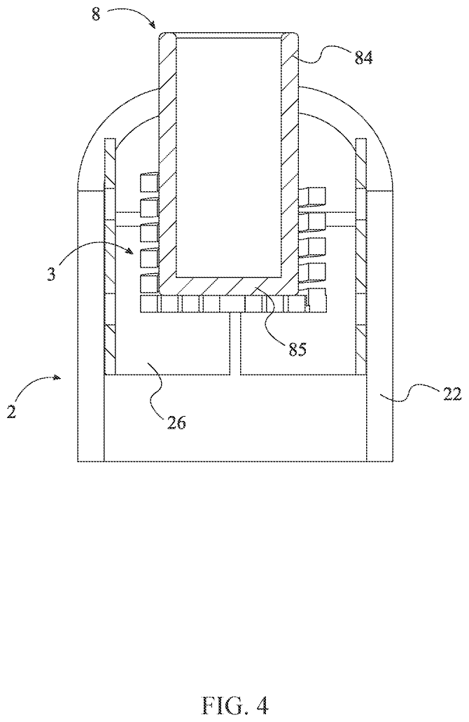

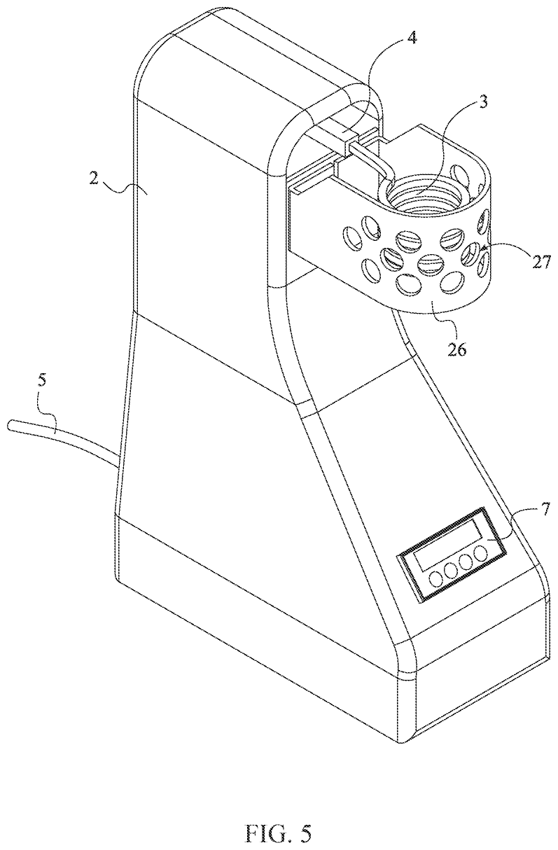

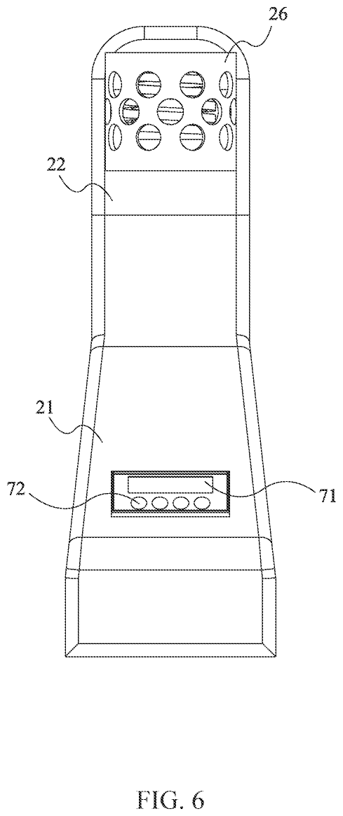

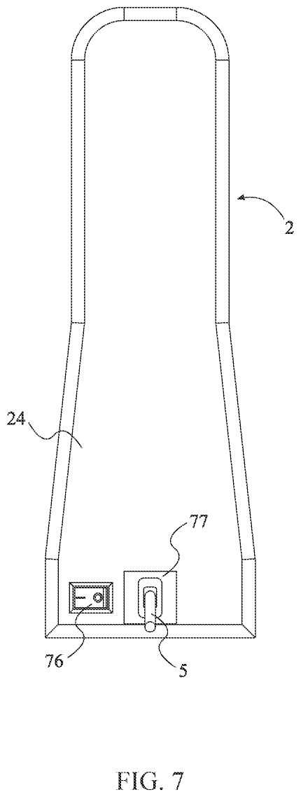

In order to accomplish the above-mentioned functioning, the present invention comprises a case 2, a heating element 3, a heat guard 26, a temperature sensor 4, a power source 5, a microcontroller 6, a user interface 7, and a quartz labware 8. As best seen in FIG. 1, the case 2 functions as the primary structural component of the present invention, as the remaining components of the present invention are configured upon the case 2. The case 2 can take a large number of shapes and can be manufactured from a variety of materials. The case 2 constitutes the primary housing that holds the important electric and electronic components of the present invention in a closed and safe location. The case 2 further comprises a lower section 21 and an upper section 22. A bottom side 23 of the lower section 21 can be removably mounted to any flat surface. As best seen in FIG. 3, the heating element 3 is mounted to the upper section 22 of the case 2, extending outward. Stated another way, the heating element 3 is externally mounted to the upper section 22 of the case 2. To protect the user from burns, the heat guard 26 is mounted to the upper section 22 of the case 2, extending outward and encircling the heating element 3. To detect the temperature at the heating element 3, the temperature sensor 4 is positioned in close proximity to the heating element 3. Preferably, the temperature sensor 4 is fixedly attached to the heating element 3, as can be seen in FIG. 5. The user interface 7 is mounted to the lower section 21 of the case 2, such that the LED screen 71 and push buttons 72 are facing outward in the direction of the user, as best seen in FIG. 6. The microcontroller 6 is mounted internally inside the case 2, thereby isolating the microcontroller 6 from hazards in the external environment. Furthermore, as can be seen in FIG. 7, the present invention may comprise at least one electrical connector 77 which may be mounted onto a back side 24 of the case 2. The electrical connector 77 provides electrical connectivity between the power source 5 and any externally supplied power (e.g., 110V AC household outlet). The present invention may also comprise a power switch 76 that is externally mounted to the case 2 for shutting the power off when not in use. Lastly, as seen in FIG. 4, the heating element 3 is operably connected to the quartz labware 8. Stated another way, the heating element 3 is adapted to fit the quartz labware 8, such that the quartz labware 8 slidably engages with the heating element 3 from the top. This arrangement serves two functions. First, the heating element 3 provides vertical support and holds the quartz labware 8 in place. Second, and most important, this arrangement allows the heating element 3 to surround the bottom surface 85 and sidewall 84 of the quartz labware 8, thereby properly heating the quartz labware 8 to the desired temperature.

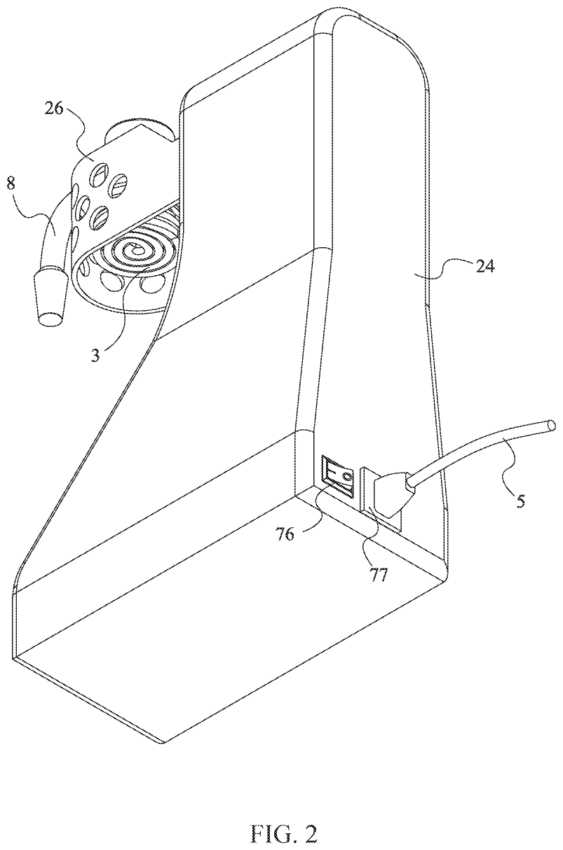

The power source 5 of the present invention provides power to all of the heating and control systems. In the preferred embodiment, the power source 5 comprises a standard 110V AC power cord, as best seen in FIG. 2. The 110V power is then converted to the correct power needed for each of the components of the present invention. In other embodiments, other power sources may be utilized including but not limited to varied voltage for different countries, DC power, and battery power sources.

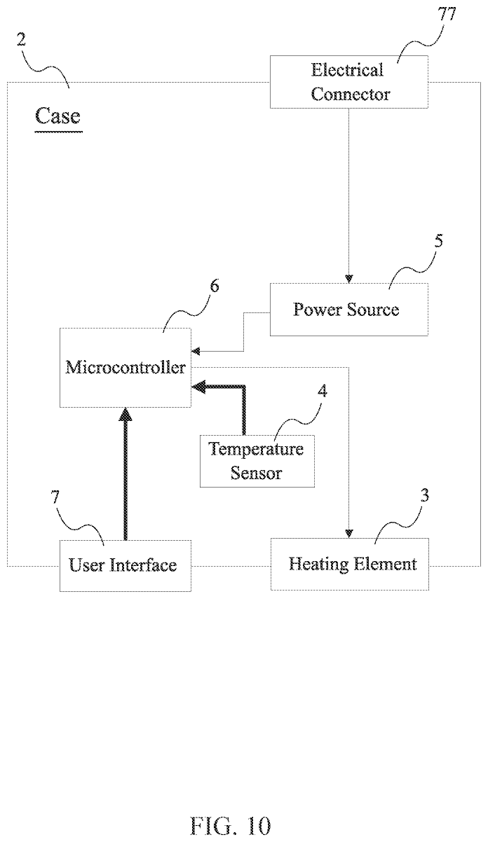

The microcontroller 6 is a processing device that manages the operation of the electrical components within the present invention. In particular, the microcontroller 6 is capable of regulating the power supplied to the heating element 3 in order to maintain a desired temperature. The microcontroller 6 utilizes the data inputs from both the temperature sensor 4 and the user interface 7 in order to accurately control the temperature of the heating element 3. As illustrated in FIG. 10, the power source 5 is electrically connected to the microcontroller 6. The heating element 3 is electrically connected and controlled by the microcontroller 6. Stated another way, the power source provides power to the microcontroller 6, such that the microcontroller 6 is capable of adjusting the power output to the heating element 3. To properly adjust the power output to the heating element 3, the microcontroller 6 is electronically connected to the user interface 7 and the temperature sensor 4. In this arrangement, the user can adjust the push buttons 72 on the user interface 7 to input the desired temperature. The microcontroller 6 then receives the input of the desired temperature from the user interface 7. At the same time, the microcontroller 6 continuously detects the temperature of the heating element 3 via the input from the temperature sensor 4. With these two inputs, the microcontroller 6 adjusts the power supplied to the heating element 3 in order to achieve and maintain the desired temperature at the heating element 3. More specifically, the microcontroller 6 supplies power to the heating element 3 until the temperature sensor 4 detects the desired temperature. Once achieved, power to the heating element 3 is continually adjusted to maintain the desired temperature.

The user interface 7 allows the user to interact with the present invention by sending various commands to the microcontroller 6. As seen in FIG. 6, the user interface 7 further comprises an LED screen 71 and a plurality of push buttons 72. The plurality of push buttons 72 enable the user to adjust the desired temperature. The LED screen 71 is capable of displaying the desired temperature to the user. In other embodiments, the plurality of push buttons 72 enable further functions and features including but not limited to temperature presets, timers, and alerts. In particular, the user can preset an alert to notify the user when a certain function is completed (e.g., desired temperature achieved) or preset a timer to indicate a desired amount of time to elapse.

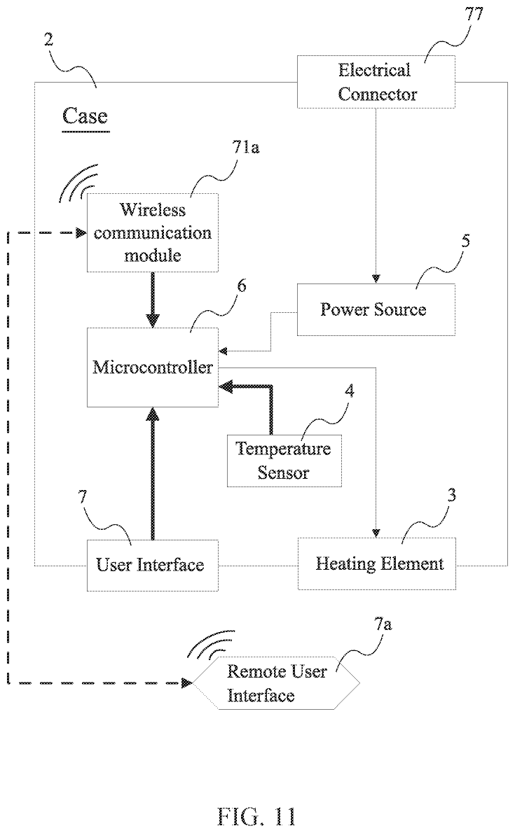

In another embodiment, the present invention further comprises a remote user interface 7a and a wireless communication module 71a. In this embodiment, the user has the option to wirelessly transmit commands to the heating apparatus 1 via the remote user interface 7a (e.g., mobile app, tablet, remote control device). The commands may include but are not limited to the desired temperature input, timers, and alerts. As illustrated in FIG. 11, the wireless communication module 71a is mounted within the case 2 and is electronically connected to the microcontroller 6. The wireless communication module 71a comprises Wi-Fi and Bluetooth capabilities, such that the wireless communication module 71a may communicate with the remote user interface 7a via wireless data transmission protocols. Example standards of what the wireless communication module 71a is capable of using includes, but are not limited to, Bluetooth, WI-FI, GSM, CDMA, ZigBee, etc.

In the preferred embodiment, the heating element 3 is an axially wound electric coil. As best seen in FIG. 4, the axially wound coil is in the shape of a receptacle (e.g., a cup), designed to wrap around the bottom surface 85 and sidewall 84 of the quartz labware 8. Stated another way, the heating element 3 is operably connected to the quartz labware 8. This arrangement provides efficient heat transfer between the heating element 3 and the quartz labware 8, enabling the quartz labware 8 to properly heat up until reaching the user's desired temperature. In other embodiments, the heating element 3 may utilize any suitable means of heating the quartz labware 8, including but not limited to custom molded or shaped ceramic heaters, a matrix of flat plate heaters, and other coiled or shaped heating elements.

In the preferred embodiment, the heat guard 26 is a rigid member that can take the form of any shape necessary to encircle the heating element 3. This arrangement prevents the user from inadvertently touching or contacting the heating element 3 during use. As can be seen in FIG. 5, the heat guard 26 may further comprise a plurality of vent holes 27. The vent holes 27 allow the heat guard 26 to dissipate heat effectively. Preferably, the heat guard 26 is constructed from aluminum. However, the material of the heat guard 26 is not limited and can be made from any other suitable material.

In the preferred embodiment, the temperature sensor 4 is a thermocouple. As best seen in FIG. 5, the thermocouple is fixedly attached to the heating element 3, which allows the thermocouple to detect the temperature of the heating element 3 with high accuracy. In other embodiments, any suitable means for measuring temperature may be used, such as but not limited to infrared sensors, or other thermometers. Further, in these embodiments, the temperature sensor 4 may be located in any suitable location where the temperature sensor 4 is capable of measuring or detecting the temperature of the heating element 3.

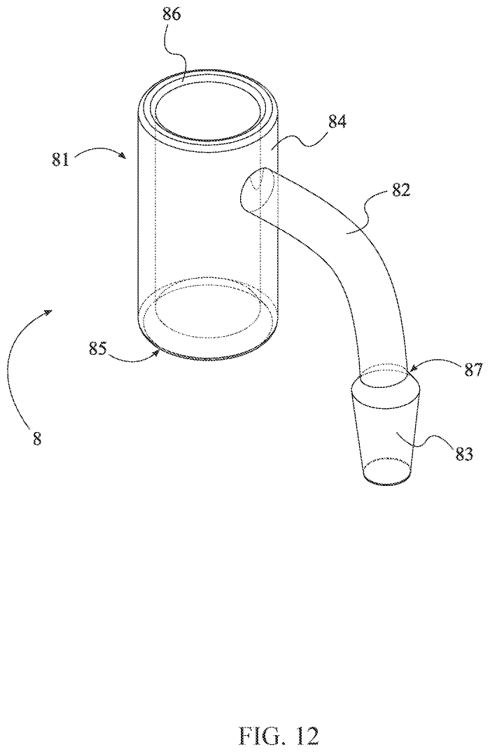

The quartz labware 8 is a type of extraction implement primarily used for vaporizing concentrates or essential oils. Preferably, the quartz labware 8 is constructed from quartz, which tends to be more resilient and resistant to damage and wear caused by high temperature and temperature cycling during vaporization. In other embodiments, the quartz labware 8 can be constructed of other materials such as but not limited to ceramics, sapphire, ruby, or glass. As seen in FIG. 12, the quartz labware 8 further comprises a bucket 81, a stem 82, and a connector 83. The bucket 81 is a tube-shaped receptacle, having a bottom surface 85, a sidewall 84, and an open top 86. The sidewall 84 extends perimetrically from the bottom surface 85 to the open top 86. The stem 82 is a tube that extends outward from the sidewall 84 and slopes downward. The stem 82 is in fluid communication with the bucket 81, such that gasses can pass from the bucket 81 to the stem 82. During use, the stem 82 is configured to extend outward and away from the heating element 3, as best seen in FIG. 3. This arrangement enables the stem 82 to remain cool to the touch even after the bucket 81 is heated. As a result, the user can pick up and remove the quartz labware 8 by the stem 82 without the use of protective gloves. The connector 83 is terminally connected to a distal end 87 of the stem 82, opposite of the bucket 81. The connector 83 is a standard size connector opening that allows the quartz labware 8 to be operably connected to a user's preferred glass labware. In other embodiments, the connector 83 can be manufactured in various sizes and shapes to correspond with the connection on the user's preferred glass labware.

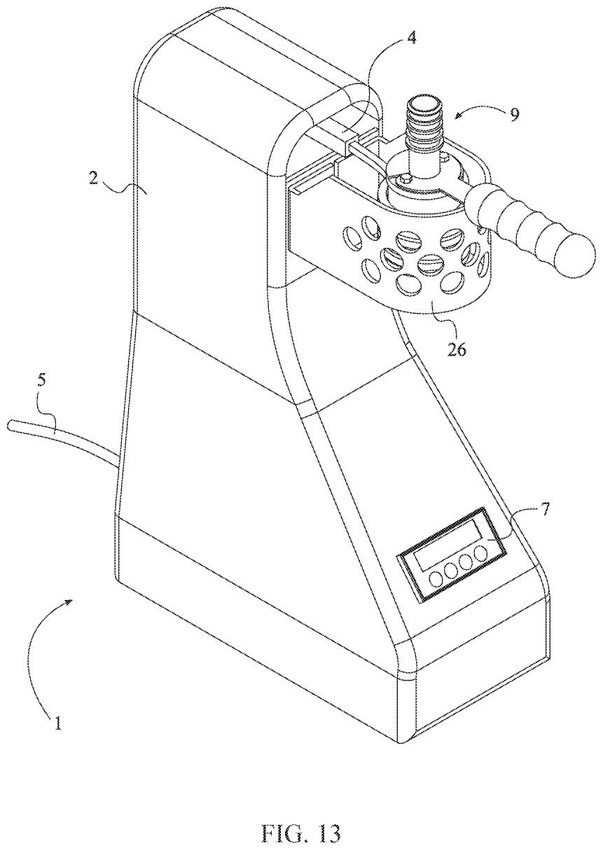

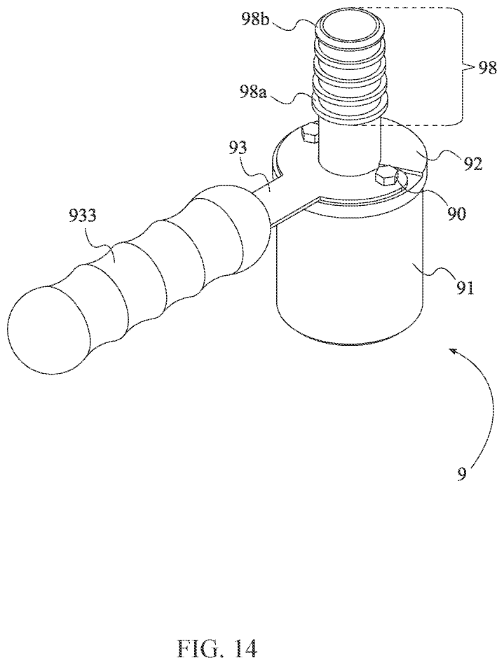

In another embodiment, as seen in FIG. 13 through FIG. 16, the heating apparatus 1 can be used for heating and maintaining the temperature of an accessory 9. The accessory 9 is a type of extraction implement primarily used for extracting vapors from dried herbs or flowers. As seen in FIGS. 14-16, the accessory 9 comprises a head 91, a peen 92, and a shank 93. The head 91 is axially aligned and detachably connected to the peen 92. Moreover, the head 91 is in fluid communication with the peen 92, such that air is capable of entering through a plurality of air inlet holes 9a on the head 91 and exiting out through a male adapter 97 on the peen 92. To pick up the accessory 9, the shank 93 is detachably connected to the peen 92. The shank 93 is oriented perpendicular to the peen 92, extending outward from the peen 92 to a proximal end 931. A plurality of fasteners 90 are used to secure the shank 93 to the peen 92, and the peen 92 to the head 91. In particular, each of the plurality of fasteners 90 extend through corresponding mounting holes 9c disposed on the peen 92, the shank 93, and the head 91.

To use the accessory 9, the user first inserts the head 91 into the heating element 3, as seen in FIG. 13. A plurality of spheres 99 inside the head 91 are heated until thermally charged. After the plurality of spheres 99 reach the desired temperature, the user then removes the accessory 9 from the heating element 3 and connects the peen 92 to an extraction chamber. The extraction chamber can be any external device, having a pass-through opening and a screen housed inside for retaining dried herbs or flowers. This arrangement allows heated air to pass through the extraction chamber without removing the dried herbs or flowers. When the accessory 9 is properly attached to the extraction chamber, ambient air first travels into the head 91 via the air inlet holes 9a. The ambient air becomes heated as it travels around the plurality of spheres 99 inside the head 91. The now-heated air exits out of the head 91 and into the peen 92 via a plurality of air outlet holes 9b on the cap 96. The heated air then travels through the male adapter 97, exits out of the accessory 9, and enters into the extraction chamber. As the heated air passes through the extraction chamber, vapors are extracted from the dried herbs and flowers.

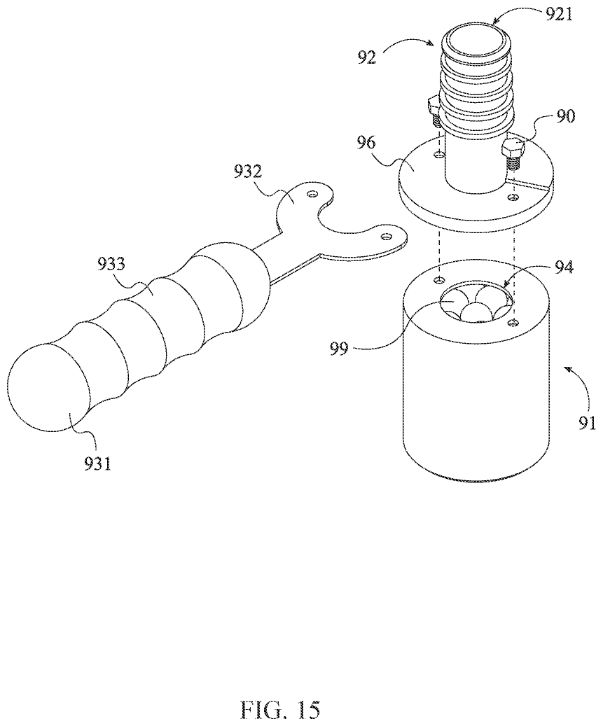

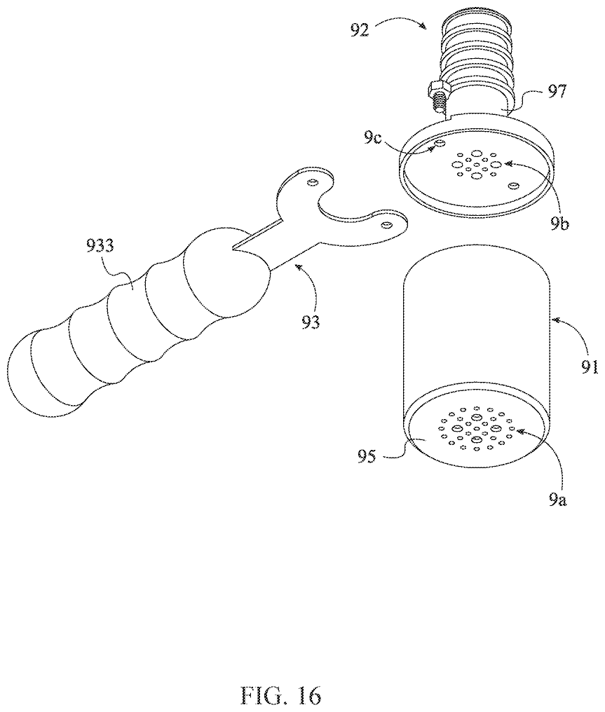

The head 91 is a cylindrical-shaped chamber, having a bottom surface 95 and a top opening 94. The head 91 is operably connected to the heating element 3, such that the heating element 3 is capable of heating and supporting the head 91. Stated another way, the head 91 is shaped to match the receptacle shape of the heating element 3, as seen in FIG. 13. This arrangement provides efficient heat transfer between the heating element 3 and the head 91, enabling the head 91 to properly heat up until reaching the user's desired temperature. As can be seen in FIG. 16, a plurality of air inlet holes 9a are disposed on the bottom surface 95 of the head 91. The top opening 94 is positioned to face upward, away from the heating element 3. Inside the top opening 94 is a plurality of spheres 99, as seen in FIG. 15. The plurality of spheres 99 are preferably ruby spheres, designed to absorb heat when exposed to high temperatures, as well as radiate heat when thermally charged. However, the material of the plurality of spheres 99 is not limited and can be made from any other material having high thermal conductivity. Preferably, the head 91 is constructed from titanium. However, the material of the head 91 is not limited and can be made from any other heat-resistant material.

The peen 92 further comprises a cap 96 and a male adapter 97. The male adapter 97 is a tube-shaped member, designed to connect to the extraction chamber during vaporization. As best seen in FIG. 16, the male adapter 97 is axially positioned on the cap 96, extending outward and away from the cap 96. The cap 96 is shaped to fit over the top opening 94 of the head 91, thereby sealing the plurality of spheres 99 within the head 91. A plurality of air outlet holes 9b are centrally disposed on the cap 96, positioned within the male adapter 97. In other words, the male adapter 97 is in fluid communication with the cap 96. This arrangement enables air to pass from the head 91 to the male adapter 97, via the air outlet holes 9b. To provide an air-tight seal between the male adapter 97 and the extraction chamber, the peen 92 further comprises a plurality of machined rings 98 perimetrically disposed along the outer wall of the male adapter 97. Preferably, the peen 92 is constructed from titanium. However, the material of the peen 92 is not limited and can be made from any other heat-resistant material.

In the preferred embodiment, the plurality of machined rings 98 are not uniform, but graduated in outside diameter, becoming increasingly smaller towards the tip 921 of the peen 92. More specifically, the plurality of machined rings 98 have a decreasing outside diameter, starting from a first machined ring 98a closest to the head 91, and ending at the last machined ring 98b closest to the tip 921. This arrangement helps dissipate heat from the head 91. By dissipating the heat, the peen 92 is less likely to stick to the extraction chamber, whereas conical-shaped connectors tend to stick to the extraction chamber due to thermal expansion at the connection point. Moreover, when using a wooden extraction chamber, the dissipation of heat by the machined rings 98 prevents the wood from being scorched.

The shank 93 is substantially rectangular in shape, having a distal end 932 and a proximal end 931. To secure the shank 93 to the peen 92, the distal end 932 of the shank 93 is shaped to slidably engage with the male adapter 97 and seat flush up against the cap 96. Preferably, a ribbed handle grip 933 is fixedly attached to the proximal end 931 of the shank 93 for improved handling, as seen in FIG. 15. The shank 93 is preferably constructed from stainless steel. However, the material of the shank 93 is not limited and can be made from any other suitable material.

Although the invention has been explained in relation to its preferred embodiment, it is to be understood that many other possible modifications and variations can be made without departing from the spirit and scope of the invention.

What is claimed is:

1. A heating apparatus comprising:
a case;
a heating element;
a temperature sensor;
a power source;
a microcontroller;
a user interface;
the heating element being externally mounted to the case;
the heating element being in the form of a receptacle;
the temperature sensor being configured to sense a temperature of the heating element;
the user interface being configured to receive input of a desired temperature of heating of the heating element;
the temperature sensor being in communication with the microcontroller;
the user interface being in communication with the microcontroller; and
the microcontroller being configured to control the supply of power to the heating element, such that the temperature of the heating element is maintained at the desired temperature.

2. The heating apparatus as claimed in claim 1 comprising:
a quartz labware;
the quartz labware further comprising a bucket and a stem;
the bucket comprising a bottom surface, an open top, and a sidewall;
the stem being in fluid communication with the bucket; and
the bucket being operably connected to the heating element, wherein the heating element is capable of holding and heating the bucket.

3. The heating apparatus as claimed in claim 2 comprising:
the quartz labware further comprising a connector;
the stem extending outward from the sidewall, sloping downward;
the stem extending away from the heating element; and
the connector being terminally connected to a distal end of the stem.

4. The heating apparatus as claimed in claim 1 comprising:
an accessory;
the accessory further comprising a head and a peen;
the head being in the form of a chamber;
the head comprising a bottom surface and a top opening;
a plurality of air inlet holes being disposed on the bottom surface of the head;
the peen comprising a cap and a male adapter;
the male adapter being axially positioned on the cap;
the male adapter being in fluid communication with the cap;
the peen being detachably connected the head;
the head being in fluid communication with the peen; and
the head being operably connected to the heating element, wherein the heating element is capable of holding and heating the head.

5. The heating apparatus as claimed in claim 4 comprising:
the accessory further comprising a shank and a handle grip;
the shank being positioned perpendicular to the peen;
a distal end of the shank being connected to the peen; and
the handle grip being fixedly attached to a proximal end of the shank.

6. The heating apparatus as claimed in claim 4 comprising:
the accessory further comprising a plurality of spheres;
the plurality of spheres being disposed within the head;
the plurality of spheres capable of being thermally charged via the heating element; and
the plurality of spheres capable of heating air flowing through the head.

7. The heating apparatus as claimed in claim 1 comprising:
a remote user interface and a wireless communication module;
the wireless communication module being in communication with the microcontroller;
the remote user interface being communicably connected to the wireless communication module; and
the remote user interface being configured to receive input of a desired temperature of heating of the heating element.

8. The heating apparatus as claimed in claim 1 comprising:
a heat guard;
the heat guard being externally mounted to the case; and
the heat guard extending outward, surrounding the heating element.

9. The heating apparatus as claimed in claim 1 comprising:
the heating element being an axially wound electric coil;
the temperature sensor being a thermocouple; and
the temperature sensor being fixedly attached to the heating element.

10. A heating apparatus comprising:
a case;
a heating element;
a temperature sensor;
a power source;
a microcontroller;
a user interface;
a heat guard;
the heating element being externally mounted to the case;
the heating element being in the form of a receptacle;
the heat guard being externally mounted to the case;
the heat guard extending outward, surrounding the heating element;
the heating element being an axially wound electric coil;
the temperature sensor being a thermocouple;
the temperature sensor being fixedly attached to the heating element;
the temperature sensor being configured to sense a temperature of the heating element;
the user interface being configured to receive input of a desired temperature of heating of the heating element;
the temperature sensor being in communication with the microcontroller;
the user interface being in communication with the microcontroller; and
the microcontroller being configured to control the supply of power to the heating element, such that the temperature of the heating element is maintained at the desired temperature.

11. The heating apparatus as claimed in claim 10 comprising:
a quartz labware;
the quartz labware further comprising a bucket, a stem, and a connector;
the bucket comprising a bottom surface, an open top, and a sidewall;
the stem being in fluid communication with the bucket;
the bucket being operably connected to the heating element, wherein the heating element is capable of holding and heating the bucket;
the stem extending outward from the sidewall, sloping downward;
the stem extending away from the heating element; and
the connector being terminally connected to a distal end of the stem.

12. The heating apparatus as claimed in claim 10 comprising:
an accessory;
the accessory further comprising a head and a peen;
the head being in the form of a chamber;
the head comprising a bottom surface and a top opening;
a plurality of air inlet holes being disposed on the bottom surface of the head;
the peen comprising a cap and a male adapter;
the male adapter being axially positioned on the cap;
the male adapter being in fluid communication with the cap;
the peen being detachably connected the head;
the head being in fluid communication with the peen; and
the head being operably connected to the heating element, wherein the heating element is capable of holding and heating the head.

13. The heating apparatus as claimed in claim 12 comprising:
the accessory further comprising a shank and a handle grip;
the shank being positioned perpendicular to the peen;
a distal end of the shank being connected to the peen; and
the handle grip being fixedly attached to a proximal end of the shank.

14. The heating apparatus as claimed in claim 12 comprising:
the accessory further comprising a plurality of spheres;
the plurality of spheres being disposed within the head;
the plurality of spheres capable of being thermally charged via the heating element; and
the plurality of spheres capable of heating air flowing through the head.

15. The heating apparatus as claimed in claim 10 comprising:
a remote user interface and a wireless communication module;
the wireless communication module being in communication with the microcontroller;
the remote user interface being communicably connected to the wireless communication module; and
the remote user interface being configured to receive input of a desired temperature of heating of the heating element.

16. A heating apparatus comprising:
a case;
a heating element;
a temperature sensor;
a power source;
a microcontroller;
a user interface;
a heat guard;
a remote user interface;
a wireless communication module;
the heating element being externally mounted to the case;
the heating element being in the form of a receptacle;
the heat guard being externally mounted to the case;
the heat guard extending outward, surrounding the heating element;
the heating element being an axially wound electric coil;
the temperature sensor being a thermocouple;
the temperature sensor being fixedly attached to the heating element;
the temperature sensor being configured to sense a temperature of the heating element;
the user interface being configured to receive input of a desired temperature of heating of the heating element;
the temperature sensor being in communication with the microcontroller;
the user interface being in communication with the microcontroller;
the wireless communication module being in communication with the microcontroller;
the remote user interface being communicably connected to the wireless communication module;
the remote user interface being configured to receive input of a desired temperature of heating of the heating element; and
the microcontroller being configured to control the supply of power to the heating element, such that the temperature of the heating element is maintained at the desired temperature.

17. The heating apparatus as claimed in claim 16 comprising:
a quartz labware;
the quartz labware further comprising a bucket, a stem, and a connector;
the bucket comprising a bottom surface, an open top, and a sidewall;
the stem being in fluid communication with the bucket;
the bucket being operably connected to the heating element, wherein the heating element is capable of holding and heating the bucket;
the stem extending outward from the sidewall, sloping downward;
the stem extending away from the heating element; and
the connector being terminally connected to a distal end of the stem.

18. The heating apparatus as claimed in claim 16 comprising:
an accessory;
the accessory further comprising a head and a peen;
the head being in the form of a chamber;
the head comprising a bottom surface and a top opening;
a plurality of air inlet holes being disposed on the bottom surface of the head;
the peen comprising a cap and a male adapter;
the male adapter being axially positioned on the cap;
the male adapter being in fluid communication with the cap;
the peen being detachably connected the head;
the head being in fluid communication with the peen; and
the head being operably connected to the heating element, wherein the heating element is capable of holding and heating the head.

19. The heating apparatus as claimed in claim 18 comprising:
the accessory further comprising a shank and a handle grip;
the shank being positioned perpendicular to the peen;
a distal end of the shank being connected to the peen; and
the handle grip being fixedly attached to a proximal end of the shank.

20. The heating apparatus as claimed in claim 18 comprising:
the accessory further comprising a plurality of spheres;
the plurality of spheres being disposed within the head;
the plurality of spheres capable of being thermally charged via the heating element; and
the plurality of spheres capable of heating air flowing through the head.
